(19) United States
(12) Patent Application Publication
(10) Pub. No.: US 2019/0185696 A1
(43) Pub. Date: Jun. 20, 2019

(54) Selective Matte And Glossy Printing

(71) Applicant: SCODIX LTD., Rosh Ha'ain (IL)

(72) Inventors: Gregory Nakhmanovich, Oranit (IL); Eliane Liraz, Raanana (IL)

(21) Appl. No.: 16/328,739

(22) PCT Filed: Jun. 25, 2017
(86) PCT No.: PCT/IB2017/053788

§ 371 Date: Feb. 27, 2019

Related U.S. Application Data
(60) Provisional application No. 62/380,428, filed on Aug. 28, 2016.

(51) Int. Cl. C09D 11/38; B41J 11/00

(52) U.S. Cl. CPC C09D 11/38; B41J 11/002

(57) ABSTRACT

An inkjet ink composition comprising: one or more UV curable monomers; oligomers having one or more acrylic groups; one or more photoinitiators; one or more surfactants; and paraffin wax.

### CROSS-REFERENCE TO RELATED PATENT APPLICATIONS

This patent application claims priority from and is related to U.S. Provisional Patent Application Ser. No. 62/380,428, filed 28 Aug. 2016, this U.S. Provisional Patent Application incorporated by reference in its entirety herein.

### TECHNOLOGY FIELD

The invention relates to ink jet printing. More particularly, the invention relates to gloss control.

### BACKGROUND

UV curing is based on photoinitiated polymerisation of functional oligomers and monomers into a crosslinked polymer network. When an ultraviolet curable coating is exposed to UV energy in this way a relatively hard film, having an extremely smooth surface, and hence one of high gloss, is produced. With the increasing popularity of radiation cured coatings for a wide variety of applications, the ability to control and reduce gloss is becoming more important. It is well known that matt surfaces provide the finished article with a more elegant appearance and hide imperfections at the surface, particularly in wood, furniture and PVC flooring applications, and several different methods of reducing the gloss of UV curable coatings have been reported, for example the use of “dual cure” or “gradient intensity cure” techniques, specific photoinitiators and non-silica type matting agents.

Traditional silica matting agents are conveniently used to reduce the gloss of solvent and water based finishes and in the UV industry synthetic silicas are used to provide a semi-gloss or matt effect, although as a rule high concentrations are generally required by the formulator. Usually, matting UV-curing systems require a very high content of the matting agents. The reason is a direct result of the high-solids nature of these systems and the inherent lack of film shrinkage during drying and curing. Such high levels of silica can frequently cause changes in the rheological properties of the lacquer which can be detrimental to the coating and curing process and, can impair the optical properties of the cured film.

The complexity arises because of the wide range of formulation possibilities, which in turn give rise to widely differing levels of film shrinkage and drying/curing characteristics.

In an attempt to overcome this problem, the use of large particle size silicas has been promoted in the past for both thin and thick film applications

Silica based matting agents may be commercially available for example from Grace under trade name SILOID. They are well defined, highly porous, synthetic amorphous silica (SiO2) of high purity. These materials consist of particles of 3-20 micron. Smaller particles are not effective for matting.

It is well known that commercially available print heads are not tolerant to abrasive solids like silica, especially if they are in high concentration and have particle size bigger than 1 micron.

All these make silica matting agents not suitable for ink jet printing.

There is need for a matting ink suitable for inkjet printing.

### SUMMARY

According to a first aspect of the present invention there is provided an inkjet ink composition comprising: one or more UV curable monomers; oligomers having one or more acrylic groups; one or more photoinitiators; one or more surfactants; and paraffin wax.

The one or more UV curable monomers may comprise monomers having one acrylic group.

The one or more UV curable monomers may comprise monomers having two acrylic groups.

The one or more UV curable monomers may comprise monomers having three or more acrylic groups;

The monomers having one acrylic group may comprise 1-60% of said inkjet ink composition.

The monomers having one acrylic group may comprise 40-50% of said inkjet ink composition.

The monomers having one acrylic group may be selected from the group consisting of: isobornyl acrylate, lauryl acrylate, tetrahydrofurfuryl acrylate, phenoxyethyl acrylate and ethoxyethoxyethyl acrylate.

The monomers having two acrylic groups may comprise 0-60%, of said inkjet ink composition.

The monomers having two acrylic groups may comprise 30-40%, of said inkjet ink composition.

The monomers having two acrylic groups may be selected from the group consisting of: 1,6-hexanediol diacrylate (HDDA), dipropylene glycol diacrylate and tripropylene glycol diacrylate.

The monomers having three or more acrylic groups may comprise 0-20%, of said inkjet ink composition.

The monomers having two acrylic groups may comprise 10-20%, of said inkjet ink composition.

The monomers having two acrylic groups may be selected from the group consisting of: trimethylolpropane triacrylate, pentaerythritol tetraacrylate, dipentaerythritol hexaacrylate.

The oligomers having one or more acrylic groups may comprise 0-20%, of said inkjet ink composition.

The oligomers having one or more acrylic groups may comprise 10-15%, of said inkjet ink composition.

The one or more acrylic groups may be selected from the group consisting of: Genomer 2235 (Rahn), Genomer 2253 (Rahn), Photomer 3005 (IGM), polyester acrylates such as Ebecryl 83 (Allnex), Photomer 5429 (IGM), Genomer 3611 (Rahn), urethane acrylates such as CN9210 (Sartomer), CN925 (Sartomer) and Genomer 4690 (Rahn).

The one or more photoinitiators may comprise 1-10%, of said inkjet ink composition.

The one or more photoinitiators may comprise 5-10%, of said inkjet ink composition.

The one or more photoinitiators may be selected from the group consisting of: alpha hydroxy ketones, alpha amino ketones and phosphine oxides.

The alpha hydroxy ketones may be selected from the group consisting of: Irgacure 184, Irgacure 1171 and Irgacure 2959.

The alpha amino ketones may be selected from the group consisting of: Irgacure 369 and Irgacure 907.

The phosphine oxides may be selected from the group consisting of: BAPO, TPO and TPO-L.

The one or more surfactants may comprise 0-2%, of said inkjet ink composition.

The one or more surfactants may comprise 0.5-1%, of said inkjet ink composition.

The one or more surfactants may be selected from the group consisting of: BYK 333, BYK UV 3500, TegoRad 2200N and TegoGlide 432.

The paraffin wax may comprise 0.1-2%, of said inkjet ink composition.

The paraffin wax may have a melting point between 50 and 70° C.

The paraffin wax may have a melting point between 60 and 65° C.

According to another aspect of the present invention there is provided a method of printing matte images comprising: introducing the inkjet ink composition of claim 1 into a pre-heated inkjet head; using said inkjet head to print said ink onto a substrate; and UV curing said printed ink.

According to another aspect of the present invention there is provided a method of printing glossy images comprising: introducing the inkjet ink composition of claim 1 into a pre-heated inkjet head; using said inkjet head to print said ink onto a substrate; heating said printed substrate; and UV curing said printed ink.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic diagram of the process resulting in gloss images; and

FIG. 2 is a schematic diagram of the process resulting in matte images.

### DETAILED DESCRIPTION OF SOME EMBODIMENTS

The present invention provides a novel inkjet ink capable of producing either matte or glossy images.

In some embodiments of the invention, the ink may contain one or more UV curable monomers including, but not limited to, esters of acrylic acid.

The ink may contain monomers having one acrylic group. Examples of such compounds include, but not limited to isobornyl acrylate, lauryl acrylate, tetrahydrofurfuryl acrylate, phenoxyethyl acrylate, ethoxyethoxyethyl acrylate. The ink may contain 1-60%, preferably 40-50% of such monomers.

The ink may contain monomers having two acrylic groups. Examples of such compounds include, but not limited to 1,6-hexanediol diacrylate (HDDA), dipropylene glycol diacrylate, tripropylene glycol diacrylate. The ink may contain 0-60%, preferably 30-40% of such monomers.

The ink may contain monomers having three or more acrylic groups. Examples of such compounds include, but not limited to trimethylolpropane triacrylate, pentaerythritol tetraacrylate, dipentaerythritol hexaacrylate. The ink may contain 0-20%, preferably 10-20% of such monomers.

The ink may contain oligomers having one or more acrylic groups. Examples of such compounds include, but not limited to epoxy acrylates such as Genomer 2235 (Rahn), Genomer 2253 (Rahn), Photomer 3005 (IGM), polyester acrylates such as Ebecryl 83 (Allnex), Photomer 5429 (IGM), Genomer 3611 (Rahn), urethane acrylates such as CN9210 (Sartomer), CN925 (Sartorner), Genomer 4690 (Rahn). The ink may contain 0-20%, preferably 10-15% of such compounds.

The ink may contain one or more photoinitiators. Examples of such compounds include, but not limited to alpha hydroxy ketones such as Irgacure 184, Irgacure 1171, Irgacure 2959, alpha amino ketones such as Irgacure 369, Irgacure 907, phosphine oxides such as BAPO, TPO, TPO-L. The ink may contain 1-10%, preferably 5-10% of such compounds.

The ink may contain one or more surfactants for example BYK 333, BYK UV 3500, TegoRad 2200N, TegoGlide 432. The ink may contain 0-2%, preferably 0.5-1% of surfactants.

The ink contains 0.1-2% of paraffin wax, having melting point between 50 to 70° C., preferably 60-65° C.

### EXAMPLE 1

Two formulation, were prepared according to the following recipes:

Formulation 1:

| | |
|---|---|
| Isobornyl acrylate (Sartomer) | 35% |
| TPGDA (Sartomer) | 30% |
| Lauryl acrylate (Sartomer) | 10% |
| Genomer 4622 (Rahn) | 15% |
| Irgacure 184 (Basf) | 4% |
| Irgacure 369 (Basf) | 3% |
| TPO (Basf) | 1% |
| Tegorad 2200N (Evonik) | 1% |
| Paraffin wax (m.p. 58-62 C.) (Sigma-Aldrich) | 1% |

All materials were stirred at elevated temperature (70° C.) until receiving a clear homogeneous liquid.

Formulation 2 (comparative):

| | |
|---|---|
| Isobornyl acrylate (Sartomer) | 36% |
| TPGDA (Sartomer) | 30% |
| Lauryl acrylate (Sartomer) | 10% |
| Genomer 4622 (Rahn) | 15% |
| Irgacure 184 (Basf) | 4% |
| Irgacure 369 (Basf) | 3% |
| TPO (Basf) | 1% |
| Tegorad 2200N (Evonik) | 1% |

All materials were stirred until receiving a clear homogeneous liquid.

Four films were prepared in the following manner:

Film 1. Formulation 1 was preheated to 70° C., stirred and applied on an offset paper (UPM Finesse Premium Silk) using a drawdown 40 micron rod. Then it was cured by a medium pressure mercury UV lamp, H type, 400 mJ/cm².

Film 2. Formulation 1 was preheated to 70° C., stirred and applied on an offset paper (UPM Finesse Premium Silk) using a drawdown 40 micron rod. Then the paper with the applied ink was placed on a hot plate preheated to 150° C. for 0.5 second. After this the ink was cured immediately (when it is hot) by a medium pressure mercury UV lamp, H type, 400 mJ/cm².

Film 3. Formulation 2 was applied on an offset paper (UPM Finesse Premium Silk) using a drawdown 40 micron rod. Then it was cured by a medium pressure mercury UV lamp, H type, 400 mJ/cm².

Film 4. Formulation 2 was applied on an offset paper (UPM Finesse Premium Silk) using a drawdown 40 micron rod. Then the paper with the applied ink was placed on a hot plate preheated to 150° C. for 0.5 second. After this the ink was cured immediately (when it is hot) by a medium pressure mercury UV lamp, H type, 400 mJ/cm².

Glossiness of the films was measured by a gloss-meter (micro-TRI-gloss, BYK)

| Film | Gloss (60° measuring angle) |
|---|---|
| Film 1 | 38-42 |
| Film 2 | 85-90 |
| Film 3 | 90-92 |
| Film 4 | 90-92 |

The example demonstrates that the glossiness of film of Formulation 1 may be tuned between low and high values by changing the temperature of the liquid prior the curing. Curing the cold liquid leads to matte appearance while the hot liquid results in a gloss film. In contrast to this, the glossiness of the film of Formulation 2, which does not contain a paraffin wax, does not depend of the temperature of the liquid prior the curing.

### EXAMPLE 2

The Formulation 1 was introduced into Ricoh Gen.4 print head which was preheated to 70° C. The ink was jetted on an offset paper (UPM Finesse Premium Silk) at the resolution of 600×600 dpi and after 0.5 second it was cured by a medium pressure mercury UV lamp (400 mJ/cm²).

The image printed with Formulation 1 had a matte appearance.

The formulation 2 was printed in the same manner and the image had a matte appearance.

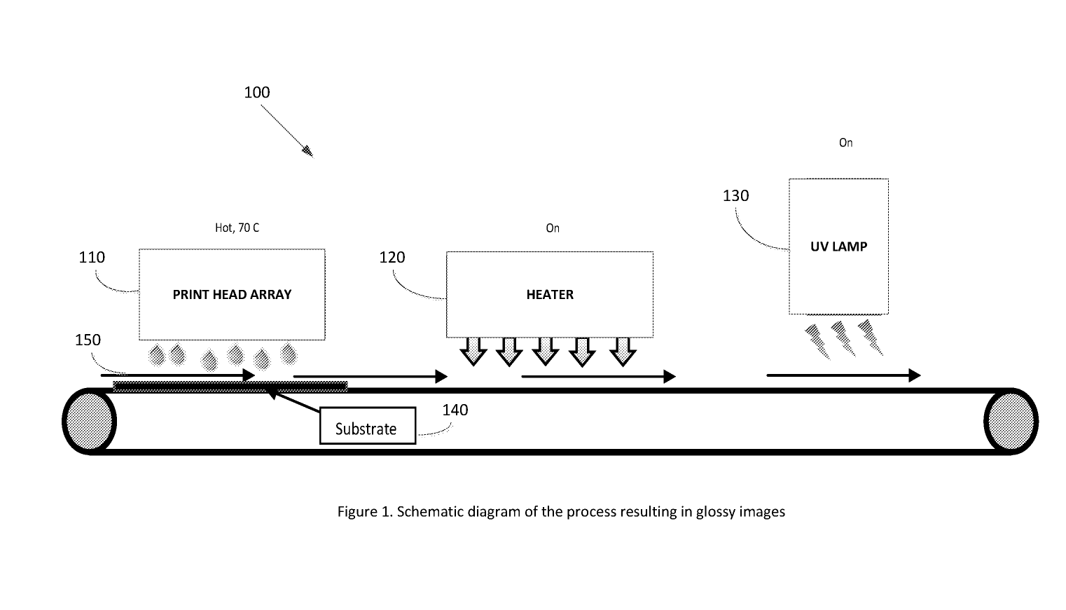

FIG. 1 is a schematic diagram of the process resulting in gloss images, comprising a substrate 140, a print head array 110 pre-heated to 70° C., a heater 120 turned on for heating the printed substrate and a UV lamp 130 for curing the ink.

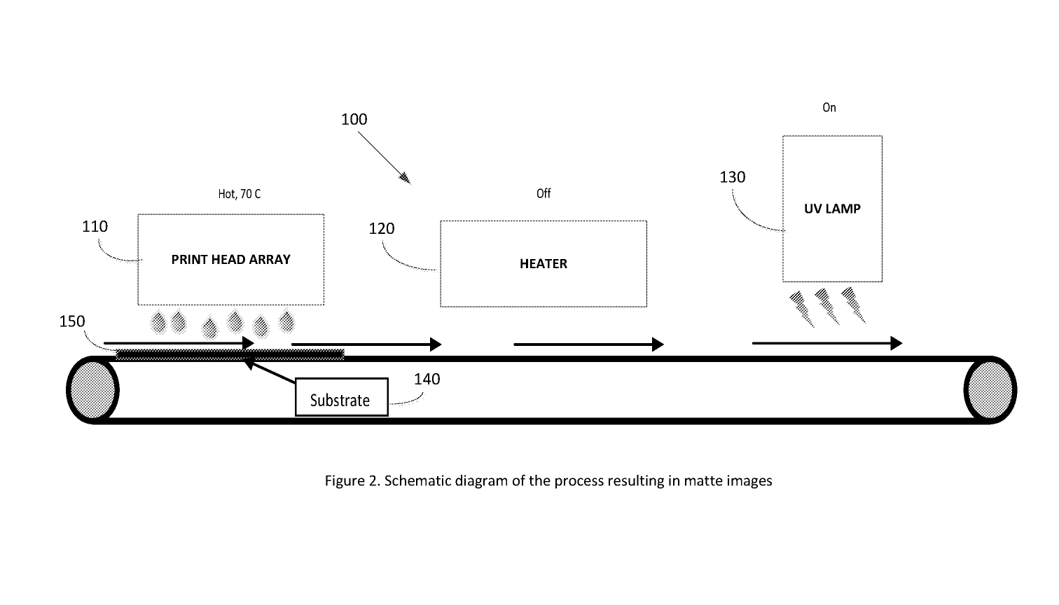

FIG. 2 is a schematic diagram of the process resulting in matte images, comprising a substrate 140, a print head array 110 pre-heated to 70° C., a heater 120 turned off (or no heater) and a UV lamp 130 for curing the ink.

1. An inkjet ink composition comprising:
one or more UV curable monomers;
oligomers having one or more acrylic groups;
one or more photoinitiators;
one or more surfactants; and
paraffin wax,
wherein said paraffin wax comprises 0.1-2%, of said inkjet ink composition,
said ink composition configured to print variable glossiness films according to the temperature of the ink composition prior to curing.

2. The inkjet ink composition of claim 1, wherein said one or more UV curable monomers comprise one of: monomers having one acrylic group, monomers having two acrylic groups and monomers having three or more acrylic groups.

3. (canceled)

4. (canceled)

5. The inkjet ink composition of claim 2, wherein said monomers having one acrylic group comprise 1-60% of said inkjet ink composition.

6. (canceled)

7. The inkjet ink composition of claim 2, wherein said monomers having one acrylic group are selected from the group consisting of: isobornyl acrylate, lauryl acrylate, tetrahydrofurfuryl acrylate, phenoxyethyl acrylate and ethoxyethoxyethyl acrylate.

8. The inkjet ink composition of claim 2, wherein said monomers having two acrylic groups comprise 0-60%, of said inkjet ink composition.

9. (canceled)

10. The inkjet ink composition of claim 2, wherein said monomers having two acrylic groups are selected from the group consisting of: 1,6-hexanediol diacrylate (HDDA), dipropylene glycol diacrylate and tripropylene glycol diacrylate.

11. The inkjet ink composition of claim 2, wherein said monomers having three or more acrylic groups comprise 0-20%, of said inkjet ink composition.

12. (canceled)

13. The inkjet ink composition of claim 2, wherein said monomers having three or more acrylic groups are selected from the group consisting of: trimethylolpropane triacrylate, pentaerythritol tetraacrylate, dipentaerythritol hexaacrylate.

14. The inkjet ink composition of claim 1, wherein said oligomers having one or more acrylic groups comprise 0-20%, of said inkjet ink composition.

15. (canceled)

16. The inkjet ink composition of claim 1, wherein said one or more acrylic groups are selected from the group consisting of: Genomer 2235 (Rahn), Genomer 2253 (Rahn), Photomer 3005 (IGM), polyester acrylates such as Ebecryl 83 (Allnex), Photomer 5429 (IGM), Genomer 3611 (Rahn), urethane acrylates such as CN9210 (Sartomer), CN925 (Sartomer) and Genomer 4690 (Rahn).

17. The inkjet ink composition of claim 1, wherein said one or more photoinitiators comprise 1-10%, of said inkjet ink composition.

18. (canceled)

19. The inkjet ink composition of claim 1, wherein said one or more photoinitiators are selected from the group consisting of: alpha hydroxy ketones, alpha amino ketones and phosphine oxides.

20. The inkjet ink composition of claim 19, wherein said alpha hydroxy ketones are selected from the group consisting of: Irgacure 184, Irgacure 1171 and Irgacure 2959.

21. The inkjet ink composition of claim 19, wherein said alpha amino ketones are selected from the group consisting of: Irgacure 369 and Irgacure 907.

22. The inkjet ink composition of claim 19, wherein said phosphine oxides are selected from the group consisting of: BAPO, TPO and TPO-L.

23. The inkjet ink composition of claim 1, wherein said one or more surfactants comprise 0-2%, of said inkjet ink composition.

24. (canceled)

25. The inkjet ink composition of claim 1, wherein said one or more surfactants are selected from the group consisting of: BYK 333, BYK UV 3500, TegoRad 2200N and TegoGlide 432.

26. (canceled)

27. The inkjet ink composition of claim 1, wherein said paraffin wax has a melting point between 50 and 70° C.

28. The inkjet ink composition of claim 27, wherein said paraffin wax has a melting point between 60 and 65° C.

29. A method of printing matte images comprising:
introducing the inkjet ink composition of claim 1 into a pre heated inkjet head;
using said inkjet head to print said ink onto a substrate; and
UV curing said printed ink.

30. A method of printing glossy images comprising:
introducing the inkjet ink composition of claim 1 into a pre-heated inkjet head;
using said inkjet head to print said ink onto a substrate;
heating said printed substrate; and
UV curing said printed ink.
